(19) United States
(12) Patent Application Publication
(10) Pub. No.: US 2022/0414906 A1
(43) Pub. Date: Dec. 29, 2022

(54) LASER TRANSMITTER, DEPTH CAMERA AND ELECTRONIC DEVICE

(71) Applicant: BEIJING XIAOMI MOBILE SOFTWARE CO., LTD., Beijing (CN)

(72) Inventor: Hui LI, Beijing (CN)

(73) Assignee: BEIJING XIAOMI MOBILE SOFTWARE CO., LTD., Beijing (CN)

(21) Appl. No.: 17/566,325

(22) Filed: Dec. 30, 2021

(30) Foreign Application Priority Data
Jun. 29, 2021 (CN) 202110729833.1

(51) Int. Cl. G06T 7/521; G01S 17/89

(52) U.S. Cl. CPC G06T 7/521; G01S 17/89; G06T 2207/10028

(57) ABSTRACT

A laser transmitter includes an emission assembly and a phased array assembly. The emission assembly has a light outlet, and the light outlet is configured to emit a laser beam. The phased array assembly is located at the light outlet and is configured to change a direction of the laser beam emitted from the light outlet.

### CROSS REFERENCE

This application is based upon and claims priority to Chinese Patent Application No. 202110729833.1, filed on Jun. 29, 2021, the entire contents thereof are incorporated herein by reference.

### TECHNICAL FIELD

The present disclosure relates to the field of electronic technology, and in particular, to a laser transmitter, a depth camera, and an electronic device.

### BACKGROUND

Depth cameras are 3D cameras, which are capable of detecting the depth of field distance of the shooting space.

In the related art, the depth camera mainly includes a laser transmitter and a laser receiver. The laser transmitter is used to emit a laser beam to a target object, and the laser receiver is used to receive the reflected laser beam. In order to increase the field of view of the emitted laser beam, it is necessary to increase the optical power of the laser beam, i.e., to increase the electric power of the laser transmitter.

### SUMMARY

The present disclosure provides a laser transmitter, a depth camera, and an electronic device.

According to one aspect of the present disclosure, a laser transmitter is provided, including an emission assembly and a phased array assembly. The emission assembly has a light outlet, and the light outlet is configured to emit a laser beam. The phased array assembly is located at the light outlet and is configured to change a direction of the laser beam emitted from the light outlet.

According to another aspect of the present disclosure, there is provided a depth camera including a laser transmitter and a laser receiver. The laser transmitter is the aforementioned laser transmitter. The laser receiver is arranged side by side with the laser transmitter.

According to another aspect of the present disclosure, there is provided an electronic device including a housing and a depth camera. The depth camera is the aforementioned depth camera, and the depth camera is located in the housing.

### BRIEF DESCRIPTION OF THE DRAWINGS

In order to clarify the technical solutions in the examples of the present disclosure, the accompanying drawings used for illustrating the examples will be briefly described below. Obviously, the accompanying drawings in the following description show only some of the examples of the present disclosure, and other drawings may be obtained by a person of ordinary skill in the art without departing from the drawings described herein.

FIG. 1 illustrates a structural schematic diagram of a depth camera provided by examples of the present disclosure.

FIG. 2 illustrates a structural schematic diagram of a laser transmitter provided by examples of the present disclosure;

FIG. 3 illustrates a cross-sectional view in the A-A direction of the laser transmitter in

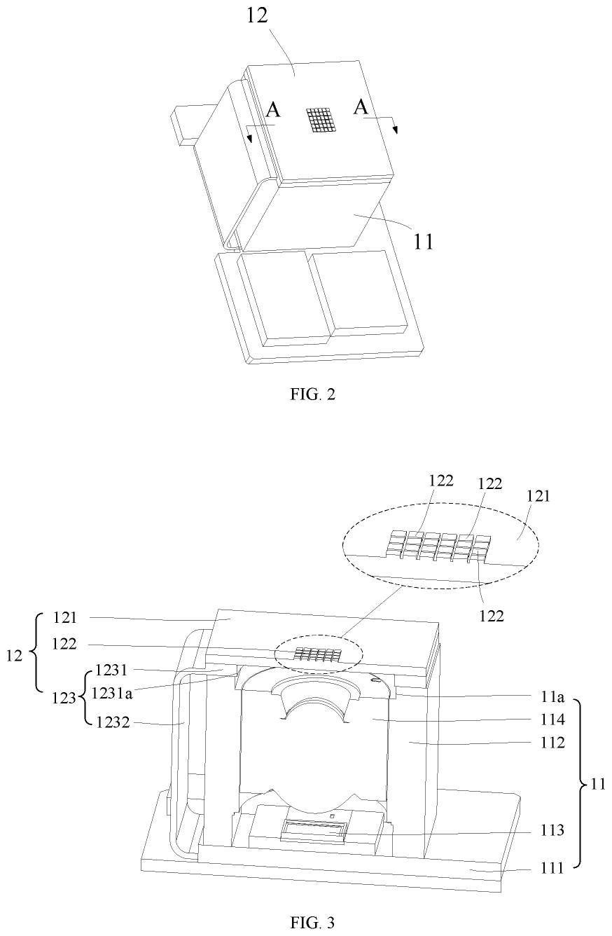

FIG. 2 as provided in the examples of the present disclosure.

FIG. 4 illustrates a schematic diagram of optical paths of laser beams provided by examples of the present disclosure.

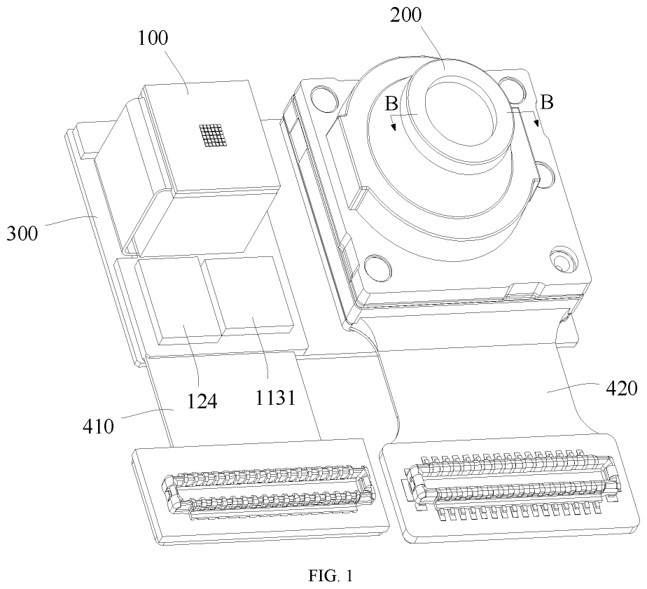

FIG. 5 illustrates a cross-sectional view in the B-B direction of the depth camera in FIG. 1 as provided in the examples of the present disclosure.

FIG. 6 illustrates a structural schematic diagram of an electronic device provided by examples of the present disclosure.

### DETAILED DESCRIPTION

In order to clarify the purpose, technical solutions and advantages of the present disclosure, examples of the present disclosure will be described in further detail below in conjunction with the accompanying drawings.

Depth cameras are 3D cameras, which are capable of detecting the depth of field distance of the shooting space.

In related art, depth cameras mainly include the following three types, which are structured light depth cameras, binocular stereo vision depth cameras and optical time of flight depth cameras.

Among them, the optical time of flight depth camera refers to TOF camera, which mainly includes a laser transmitter and a laser receiver. The laser transmitter is used to emit a laser beam to the target object, and the laser receiver is used to receive the reflected laser beam. The depth of field distance of the camera from the target object is calculated by the time difference between the emitted laser beam and the received laser beam. In order for the laser beam to irradiate more target objects, it is necessary to increase the field of view of the emitted laser beam. In this way, it is necessary to increase the optical power of the laser beam, i.e., the electric power of the laser transmitter needs to be increased.

However, as the electric power of the laser transmitter increases, the laser transmitter will generate more heat, which imposes higher requirements on the heat dissipation performance of the depth camera, and is not conducive to the long-time operation of the depth camera.

In order to solve the above technical problems, examples of the present disclosure provide a depth camera. FIG. 1 illustrates a structural schematic diagram of the depth camera. As shown in FIG. 1, the depth camera includes a laser transmitter 100 and a laser receiver 200, and the laser receiver 200 and the laser emission 100 are arranged side by side. The laser transmitter may also be referred as a laser emitter or a Laser transmitter. The laser transmitter 100 can change the deflection angle of the laser beam, so the irradiation direction of the laser beam can be adjusted, which is equivalent to realizing the scanning of the laser beam within a certain angle, i.e., increasing the field of view of the laser beam.

The deflection angle is an angle between the direction of the adjusted laser beam and the direction of the laser beam before it passes through the phased array assembly 12. The deflection angle may be 0 degrees. In some embodiments, the deflection angle is 0 degrees when no control is applied to the phased array assembly 12.

In some embodiments, the direction of the laser beam emitted from the light outlet 11a is changed by the phased array assembly 12, i.e. the deflection angle of the laser beam emitted from the outlet 11a is changed.

In addition, wavefronts of the laser beams emitted from the laser emission module 100 form an equiphase surface, and the laser beams passing through the equiphase surface are always perpendicular to the equiphase surface by the laser emission module 100 provided by embodiments of present disclosure.

Moreover, since changing the deflection angle of the laser beam does not require increasing the optical power of the laser beam, the electric power of the laser transmitter 100 will not increase, so there is no overheating problem, making the depth camera able to work for a long time. In addition, the power consumption of the depth camera will not increase and the power conversion efficiency will not decrease while the electric power remains unchanged, making the performance of the depth camera guaranteed.

It can be seen from the foregoing that the reason why the depth camera is able to increase the field of view of the laser beam without increasing the optical power of the laser beam is that the laser transmitter 100 can change the deflection angle of the emitted laser beam. This is further described below.

FIG. 2 illustrates a structural schematic diagram of a laser transmitter 100. As shown in FIG. 2, the laser transmitter 100 includes an emission assembly 11 and a phased array assembly 12.

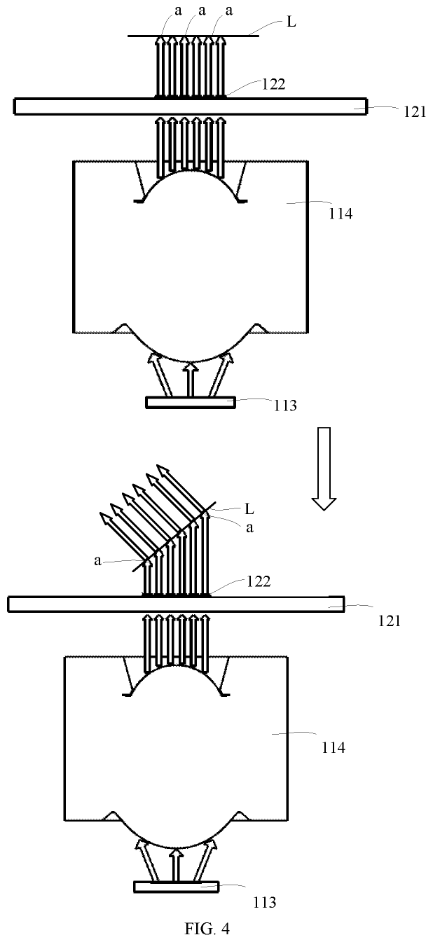

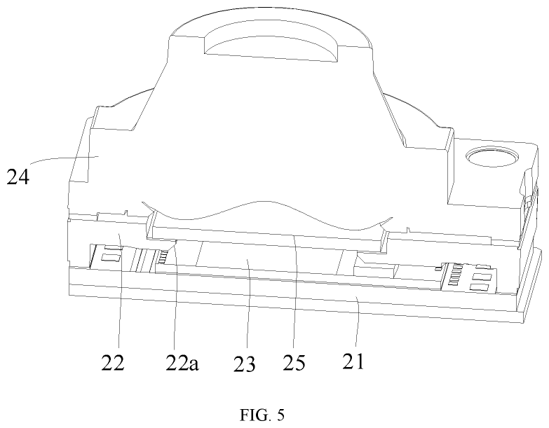

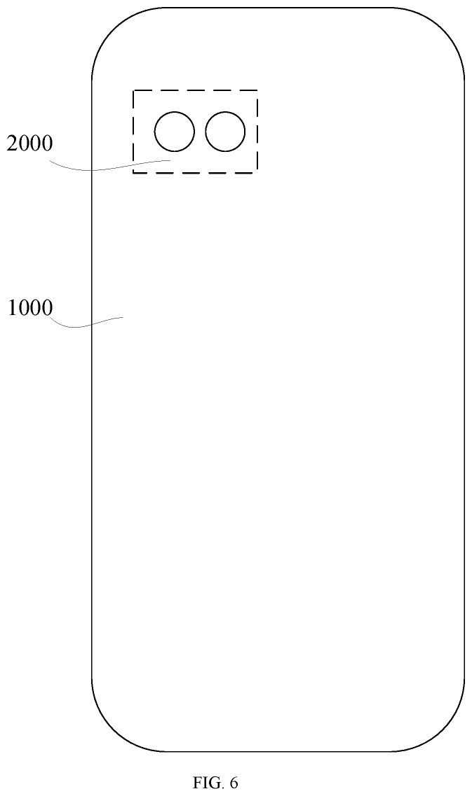

FIG. 3 illustrates a cross-sectional view in the A-A direction of the laser transmitter in FIG. 2. As shown in FIG. 3, the emission assembly 11 is provided with a light outlet 11a, and the light outlet 11a is configured to emit a laser beam. The phased array assembly 12 is located at the light outlet 11a and is configured to change a deflection angle of the laser beam emitted from the light outlet 11a.

In some embodiments, wavefronts of the laser beams emitted from the laser emission module 100 form an equiphase surface, and the laser beams passing through the equiphase surface are always perpendicular to the equiphase surface by the laser emission module 100 provided by embodiments of present disclosure.

When a laser beam is emitted by the laser transmitter 100 provided by the examples of the present disclosure, the laser beam is emitted from the light outlet 11a of the emission assembly 11 and passes through the phased array assembly 12. As the laser beam passes through the phased array assembly 12, the irradiation direction of the laser beam can be adjusted by the phased array assembly 12 because the phased array assembly 12 can change its refractive index through an electro-optical effect or a thermo-optical effect, thereby changing the deflection angle of the laser beam, which is equivalent to achieving scanning of the laser beam within a certain angle, i.e., increasing the field of view of the laser beam.

In addition, since the laser transmitter 100 provided by the examples of the present disclosure does not increase the optical power of the laser beam during the process of increasing the field of view of the laser beam, the electric power of the laser transmitter100 is not increase either, there is no problem of overheating and the laser transmitter100 can work for a long time.

It can be seen that the phased array assembly 12 plays a key role in increasing the field of view of the laser beam and will be further described below.

Referring again to FIG. 3, in this example, the phased array assembly 12 may include a circuit board component 123, a transparent substrate 121 and a plurality of phase adjustment units 122.

The circuit board component 123 is located outside the light outlet 11a and is connected to the emission assembly 11. The transparent substrate 121 is located at the light outlet 11a and is perpendicular to the laser beam emitted from the light outlet 11a. The plurality of phase adjustment units 122 are all located on a side, away from the light outlet 11a, of the transparent substrate 121 and are arranged in an array. An orthographic projection of the array formed by the plurality of phase adjustment units 122 on a plane where the light outlet 11a is located, at least partially, overlaps with the light outlet 11a.

In above example, the circuit board component 123 serves as a carrier for the transparent substrate 121 and the plurality of phase adjustment units 122, and provides electric energy to each phase adjustment unit 122 to enable the phase adjustment unit 122 to function properly. The transparent substrate 121 is configured to provide a carrier for each phase adjustment unit 122. The material of the phase adjustment unit 122 is characterized by an electro-optical effect and a thermo-optical effect. In the electro-optical effect, the refractive index of the phase adjustment unit 122 changes under the influence of an applied electric field. In the thermo-optical effect, the refractive index of the phase adjustment unit 122 changes under the influence of a change in temperature. By changing the refractive index of the phase adjustment unit 122, it is possible to produce phase differences between the laser beams passing through each phase adjustment unit 122, thus causing a phase delay. As a result, an interference occur between the laser beams, causing the laser beams in one direction to constructively interfere with each other, while the laser beams in other directions destructively interfere with each other, thus changing the deflection angle of the laser beams. In other words, by controlling the applied electric field or temperature of each unit involved, the deflection angle of the laser beam can be changed.

In some examples, one or more of the phase adjustment units 122 may include liquid crystal cells or optical waveguide units. The liquid crystal cell is characterized by the electro-optical effect, that is, the refractive index can be changed by changing the external electric field. The optical waveguide unit is characterized by the thermo-optical effect, that is, the refractive index can be changed by changing the temperature.

According to the preceding description, the orthographic projection of the array formed by the plurality of phase adjustment units 122 on the plane where the light outlet 11a is located at least partially overlaps with the light outlet 11a. That is, the orthographic projection of the array formed by the plurality of phase adjustment units 122 on the plane where the light outlet 11a is located may either cover the light outlet 11a or be covered by the light outlet 11a.

In some examples, the orthographic projection of each phase adjustment unit 122 on the plane where the light outlet 11a is located within the light outlet 11a. In this way, the phase adjustment unit 122 is prevented from being blocked by the light outlet 11a.

In other examples, the light outlet 11a is located within the orthographic projection of the array formed by the plurality of phase adjustment units 122 in the plane where the light outlet 11a is located. In this way, the laser beam can be prevented from overflowing the processing range of the phase adjustment units 122.

In order to control each phase adjustment unit 122, in this example, the circuit board component 123 includes a first circuit board 1231 and a second circuit board 1232.

The first circuit board 1231 is sandwiched between the transparent substrate 121 and the light outlet 11a, a middle part of the first circuit board 1231 is provided with a light transmission hole 1231a, and the light transmission hole 1231a is opposite to the light outlet 11a. One end of the second circuit board 1232 is connected to the first circuit board 1231, and the other end of the second circuit board 1232 is connected to the emission assembly 11.

In the above example, the first circuit board 1231 is configured to carry the transparent substrate 121 and provide power for each phase adjustment unit 122. The first circuit board 1231 can be connected to the emission assembly 11 by connecting the second circuit board 1232, and then the first circuit board 1231 can be used to provide power to the emission assembly 11, making the laser transmitter 100 more compact and conducive to the miniaturization of the depth camera.

In some examples, the first circuit board 1231 may be a printed circuit board, and the second circuit board 1232 may be a flexible circuit board. In this way, the structural strength of the printed circuit board can be used to carry the transparent substrate 121 more stably, and the flexible characteristics of the flexible circuit board can be used to facilitate the connection between the first circuit board 1231 and the emission assembly 11.

Of course, in other examples, the circuit board component 123 may also include only one circuit board, and the circuit board can not only carry the transparent substrate 121, but also can be connected to the emission assembly 11. In this case, the circuit board component 123 is a flexible circuit board to facilitate shaping.

In some examples, the second circuit board 1232 is located on the outside of the emission assembly 11, so as to prevent the second circuit board 1232 from affecting the normal operation of the emission assembly 11.

How the phased array assembly 12 deflects the laser beam has been introduced in the preceding description, and the emission assembly 11 will be introduced below.

Referring further to FIG. 3, in this example, the emission assembly 11 may include a third circuit board 111, a frame 112, and a laser chip 113.

One end of the frame 112 is connected to a surface of the third circuit board 111, the other end of the frame 11 is provided with the light outlet 11a. The laser chip 113 is located in the frame 112 and is connected to the surface of the third circuit board 111.

In the above example, the third circuit board 111 is configured to carry the frame 112 and the laser chip 113, and to supply power to the laser chip 113. The frame 112 is hollow inside and is configured to accommodate the laser chip 113. The laser chip 113 is configured to emit a laser beam so that the laser beam penetrates the inner space of the frame 112 and is emitted by the light outlet 11a.

In some examples, the third circuit board 111 may be a printed circuit board. In this way, the stronger structural strength of the printed circuit board can be used to carry the frame 112 and the laser chip 113 more stably.

In some examples, the laser chip 113 may be a Vertical-Cavity Surface-Emitting Laser (VCSEL). The laser chip 113 may include a substrate and a chip body, one surface of the substrate is connected to the third circuit board 111, and the other surface of the substrate is connected to the chip body.

In some examples, both a laser chip driver 1131 and the phased array assembly driver 124 are connected to the third circuit board 111 and are located on the same side of a holder 22 of the laser receiver 200. In this way, the laser transmitter 100 can be made more compact, which is conducive to the miniaturization of the depth camera.

In order to ensure the laser beams emitted from the light outlet 11a are collimated laser beams, in this example, the emission assembly 11 further includes a collimating lens 114. The collimator lens 114 is located between the light outlet 11a and the laser chip 113 and is connected to an inner wall of the frame 112. In this way, the laser beams are collimated by the collimating lens 114 before being emitted from the light outlet 11a, so that the laser beams emitted from the light outlet 11a are all collimated laser beams, which enables better control of the interference of the laser beams.

FIG. 4 illustrates a schematic diagram of optical paths of laser beams. The operating process of the laser transmitter 100 is introduced below in conjunction with FIG. 4.

The laser chip 113 emits laser beams. The laser beams transmit through the collimating lens 114, and are collimated into collimated laser beams under the action of the collimating lens 114. The collimated laser beams are emitted from the light outlet 11a, and sequentially transmits through the transparent substrate 121 and each phase adjustment unit 122. If no control is applied to each phase adjustment unit 122 during the transmission of the collimated laser beams through the phase adjustment units 122, the laser beams continue to propagate in the original direction as shown in upper part of FIG. 4, where an equiphase surface L formed by the wavefronts a of the laser beams is perpendicular to the laser beams before passing through the phase adjustment units 122. If the control is applied to each phase adjustment unit 122 and the refractive index of the phase adjustment unit 122 is changed, then phase differences occur between the laser beams passing through each phase adjustment unit 122, thereby causing a phase delay. The equiphase surface L formed by the wavefront a of the laser beams is tilted towards the laser beams before passing through the phase adjustment units 122. Due to the phase differences between the laser beams, there will be interference between the laser beams, resulting in deflection as shown in lower part of FIG. 4.

It should be noted that in order to achieve steady-state interference of laser beams, the following three conditions needs to be met: the frequencies of the laser beams are the same, the vibration components of laser beams are parallel to each other, and the phase difference between any adjacent laser beams is constant. Since laser beams are emitted from the same laser chip 113 and collimated by the collimating lens 114, the above-mentioned first and second conditions are met, it is only necessary to ensure that the phase difference between any adjacent laser beams is constant. For example, the phase difference between the first laser beam and the second laser beam is Δϕ, the phase difference between the second laser beam and the third laser beam is 2Δϕ, the phase difference between the third laser beam and the fourth laser is 3Δϕ, and so on. Thus, laser beams that satisfy the equiphase relation constructively interfere with each other and those that do not satisfy the equiphase relation destructively interfere with each other, so that the laser beam passing through the equiphase surface L is always perpendicular to the equiphasic plane L.

The angle of inclination of the equiphase surface L is calculated as follows.

The following equation can be obtained from the geometric relationship.

Δd=d. sin θ. (1)

Here, Δd denotes the difference in optical path between two adjacent laser beams to the equiphase plane; d denotes the distance between the two adjacent laser beams; θ denotes the angle of inclination between the equiphase plane and the laser beams before passing through phase adjustment unit 122.

In the interference light field, the light intensity distribution at the midpoint satisfies the following equation.

I=I₁+I₂+2\sqrt{I₁I₂} cos Δφ. (2)

Here, I denotes the light intensity at the midpoint in optical interference space, I₁ denotes the light intensity of the laser beam 1 at the midpoint position, I₂ denotes the light intensity of the laser beam 2 at the midpoint position, and Δφ denotes the phase difference between the two laser beams at the midpoint position.

In the interference light field, the phase difference between adjacent laser beams at the midpoint position satisfies the following equation.

$$Δφ = \frac{2 π}{{λ}_{0}} ( {n}_{2} {d}_{2} - {n}_{1} {d}_{1} ) = \frac{2 π}{{λ}_{0}} Δ d . \qquad ( 3 )$$

Here, n₁ and n₂ denote the refractive indices of the laser beam 1 and the laser beam 2 passing through the propagation medium, respectively; d₁ and d₂ denote the lengths of the laser beam 1 and the laser beam 2 through the propagation path, respectively; and λ₀ denotes the wavelength of the laser beam.

According to the equations (1) and (3), the following equation can be obtained.

$$θ = arcsin ( \frac{{λ}_{0} Δφ}{2 π d} ) . \qquad ( 4 )$$

It can be seen that under the condition that the phase difference between any adjacent laser beams is kept constant, the angle of inclination of the equiphase surface L can be determined, and thus the deflection angle of the laser beam can be determined.

The laser receiver 200 is described below.

FIG. 5 illustrates a cross-sectional view in the B-B direction of the depth camera in FIG. 1. As shown in FIG. 5, in this example, the laser receiver 200 may include a fourth circuit board 21, a holder 22 and a sensor chip 23.

The holder 22 is connected to a surface of the fourth circuit board 21 and is provided with a light inlet 22a, and the light inlet 22a is located at a side, facing away from the fourth circuit board 21, of the holder 22. The sensor chip 23 is located inside the holder 22, connected to the surface of the fourth circuit board 21, and opposite to the light inlet 22a.

In the above example, the fourth circuit board 21 is configured to carry the holder 22 and the sensor chip 23, and supply power to the sensor chip 23. The sensor chip 23 is configured to receive the laser beam entering through the light inlet 22a to calculate the depth of field distance. The holder 22 is arranged outside the sensor chip 23 to support other components and to protect the sensor chip 23.

In some examples, the fourth circuit board 21 may be a printed circuit board. In this way, the stronger structural strength of the printed circuit board can be used to carry the holder 22 and the sensor chip 23 more stably.

In some examples, the laser receiver 200 may further include a receiving lens 24 and a narrow-band filter 25.

The receiving lens 24 is located at the light inlet 22a and is connected to the holder 22. The narrow-band filter 25 is located at the light inlet 22a and is sandwiched between the receiving lens 24 and the holder 22.

The receiving lens 24 is configured to converge the reflected laser beams, so that the laser beams can pass through the narrow-band filter 25, enter the holder 22 from the light inlet 22a after filtering, and be sensed by the sensor chip 23.

Referring again to FIG. 1, in this example, the depth camera may further include a reinforcement plate 300, and the laser transmitter 100 and the laser receiver 200 are connected to a same surface of the reinforcement plate 300.

In the above example, the reinforcement plate 300 is configured to reinforce the third circuit board 111 and the fourth circuit board 21, thereby improving the structural strength of the third circuit board 111 and the fourth circuit board 21, and improving the structural strength of the depth camera.

In some examples, the laser transmitter 100 and the laser receiver 200 are extended with a first flexible circuit board 410 and a second flexible circuit board 420, respectively, to connect the connectors of the depth camera, thus facilitating the connection with other components within the depth camera.

In some examples, the first flexible circuit board 410 extended from the laser emission module 100 is connected to the third circuit board 111, and the second flexible circuit board 420 extended from the laser receiver module 200 is connected to the fourth circuit board 21. In addition, the first flexible circuit board 410 extended from the laser emission module 100 and the second flexible circuit board 420 extended from the laser receiver module 200 are located on the same side. In this way, a more compact design is possible, facilitating the miniaturization of depth cameras.

The depth camera provided by the examples of the present disclosure can meet the requirements for large deflection angle, high scanning rate, high pointing accuracy, low loss, low power consumption, and high stability through the configured laser transmitter. In addition, when emitting a laser beam through the laser transmitter, it is possible to direct a laser beam randomly over a large field of view and, in small increments, to deflect that laser beam from one angle to another and to stay on the target object for the required time.

FIG. 6 illustrates a structural schematic diagram of an electronic device provided by examples of the present disclosure. The electronic device may be a mobile phone, a tablet computer, or the like. Referring to FIG. 6, the electronic device includes a housing 1000 and a depth camera 2000.

The depth camera 2000 is the depth camera shown in FIGS. 1-5, and the depth camera 2000 is located in the housing 1000.

As the electronic device includes the depth camera shown in FIGS. 1-5, all the beneficial effects of the depth camera can be achieved and will not be repeated herein.

The present disclosure may include dedicated hardware implementations such as disclosure specific integrated circuits, programmable logic arrays and other hardware devices. The hardware implementations can be constructed to implement one or more of the methods described herein. Examples that may include the apparatus and systems of various implementations can broadly include a variety of electronic and computing systems. One or more examples described herein may implement functions using two or more specific interconnected hardware modules or devices with related control and data signals that can be communicated between and through the modules, or as portions of an application-specific integrated circuit. Accordingly, the system disclosed may encompass software, firmware, and hardware implementations. The terms “module,” “sub-module,” “circuit,” “sub-circuit,” “circuitry,” “sub-circuitry,” “unit,” or “sub-unit” may include memory (shared, dedicated, or group) that stores code or instructions that can be executed by one or more processors. The module refers herein may include one or more circuit with or without stored code or instructions. The module or circuit may include one or more components that are connected.

Those skilled in the art will easily conceive of other examples of the present disclosure after considering the specification and practicing the present disclosure disclosed herein. The present application is intended to cover any variations, uses, or adaptive changes of the present disclosure. These variations, uses, or adaptive changes follow the general principles of the present disclosure and include common knowledge or conventional technical means in the technical field that are not disclosed in the present disclosure. The description and the examples are to be regarded as exemplary only.

The above-described examples are optional only and are not intended to limit the present disclosure, and any modifications, equivalent substitutions, improvements, etc. made within the spirit and principles of the present disclosure shall be included within the scope of protection of the present disclosure.

What is claimed is:

1. A laser transmitter, comprising:
an emission assembly comprising a light outlet configured to emit a laser beam; and
a phased array assembly located at the light outlet, wherein the phased array assembly is configured to change a direction of the laser beam emitted from the light outlet.

2. The laser transmitter of claim 1, wherein the phased array assembly comprises a circuit board component, a transparent substrate and a plurality of phase adjustment units;
the circuit board component is located outside the light outlet and is connected to the emission assembly;
the transparent substrate is located at the light outlet and is perpendicular to the laser beam emitted from the light outlet;
the plurality of phase adjustment units are located on a side, away from the light outlet, of the transparent substrate and is arranged in an array; and
an orthographic projection of the array formed by the plurality of phase adjustment units on a plane where the light outlet is located, at least partially, overlaps with the light outlet.

3. The laser transmitter of claim 2, wherein the plurality of phase adjustment units comprise a liquid crystal cell or an optical waveguide unit.

4. The laser transmitter of claim 2, wherein the circuit board component comprises a first circuit board and a second circuit board;
the first circuit board is sandwiched between the transparent substrate and the light outlet, a middle part of the first circuit board has a light transmission hole, and the light transmission hole is opposite to the light outlet; and
one end of the second circuit board is connected to the first circuit board, and the other end of the second circuit board is connected to the emission assembly.

5. The laser transmitter of claim 1, wherein the emission assembly comprises a third circuit board, a frame and a laser chip;
one end of the frame is connected to a surface of the third circuit board, and the other end of the frame has the light outlet; and
the laser chip is located in the frame and is connected to the surface of the third circuit board.

6. The laser transmitter of claim 2, wherein the emission assembly comprises a third circuit board, a frame and a laser chip;
one end of the frame is connected to a surface of the third circuit board, and the other end of the frame has the light outlet; and
the laser chip is located in the frame and is connected to the surface of the third circuit board.

7. The laser transmitter of claim 3, wherein the emission assembly comprises a third circuit board, a frame and a laser chip;
one end of the frame is connected to a surface of the third circuit board, and the other end of the frame has the light outlet; and
the laser chip is located in the frame and is connected to the surface of the third circuit board.

8. The laser transmitter of claim 4, wherein the emission assembly comprises a third circuit board, a frame and a laser chip;
one end of the frame is connected to a surface of the third circuit board, and the other end of the frame has the light outlet; and
the laser chip is located in the frame and is connected to the surface of the third circuit board.

9. The laser transmitter of claim 5, wherein the emission assembly further comprises a collimating lens;
the collimating lens is located between the light outlet and the laser chip and is connected to an inner wall of the frame.

10. A depth camera, comprising a laser transmitter and a laser receiver; wherein
the laser transmitter comprises an emission assembly and a phased array assembly; wherein the emission assembly has a light outlet, and the light outlet is configured to emit a laser beam; and the phased array assembly is located at the light outlet and is configured to change a direction of the laser beam emitted from the light outlet; and
the laser receiver is arranged side by side with the laser transmitter.

11. The depth camera of claim 10, wherein the laser receiver comprises a fourth circuit board, a holder and a sensor chip;
the holder is connected to a surface of the fourth circuit board and is provided with a light inlet, and the light inlet is located at a side, facing away from the fourth circuit board, of the holder; and
the sensor chip is located inside the holder, connected to the surface of the fourth circuit board, and opposite to the light inlet.

12. The depth camera of claim 11, wherein the laser receiver further comprises a receiving lens and a narrow-band filter;
the receiving lens is located at the light inlet and is connected to the holder; and
the narrow-band filter is located at the light inlet and is sandwiched between the receiving lens and the holder.

13. The depth camera of claim 10, wherein the depth camera further comprises a reinforcement plate;
the laser transmitter and the laser receiver are connected to a same surface of the reinforcement plate.

14. The depth camera of claim 10, wherein the phased array assembly comprises a circuit board component, a transparent substrate and a plurality of phase adjustment units;
the circuit board component is located outside the light outlet and is connected to the emission assembly;
the transparent substrate is located at the light outlet and is perpendicular to the laser beam emitted from the light outlet; and
the plurality of phase adjustment units are located on a side, away from the light outlet, of the transparent substrate and is arranged in an array, and
an orthographic projection of the array formed by the plurality of phase adjustment units on a plane where the light outlet is located, at least partially, overlaps with the light outlet.

15. The depth camera of claim 14, wherein the plurality of phase adjustment units comprise a liquid crystal cell or an optical waveguide unit.

16. The depth camera of claim 14, wherein the circuit board component comprises a first circuit board and a second circuit board;
the first circuit board is sandwiched between the transparent substrate and the light outlet, a middle part of the first circuit board has a light transmission hole, and the light transmission hole is opposite to the light outlet; and
one end of the second circuit board is connected to the first circuit board, and the other end of the second circuit board is connected to the emission assembly.

17. The depth camera of claim 10, wherein the emission assembly comprises a third circuit board, a frame and a laser chip;
one end of the frame is connected to a surface of the third circuit board, and the other end of the frame has the light outlet; and
the laser chip is located in the frame and is connected to the surface of the third circuit board.

18. The depth camera of claim 17, wherein the emission assembly further comprises a collimating lens;
the collimating lens is located between the light outlet and the laser chip and is connected to an inner wall of the frame.

19. An electronic device, comprising:
a depth camera located in a housing, wherein the depth camera comprises a laser transmitter and a laser receiver;
wherein the laser transmitter comprises an emission assembly and a phased array assembly; the emission assembly has a light outlet, and the light outlet is configured to emit a laser beam; and the phased array assembly is located at the light outlet and is configured to change a direction of the laser beam emitted from the light outlet; and
wherein the laser receiver is arranged side by side with the laser transmitter.

20. The electronic device of claim 19, the phased array assembly comprises a circuit board component, a transparent substrate and a plurality of phase adjustment units;
the circuit board component is located outside the light outlet and is connected to the emission assembly;
the transparent substrate is located at the light outlet and is perpendicular to the laser beam emitted from the light outlet; and
the plurality of phase adjustment units are located on a side, away from the light outlet, of the transparent substrate and is arranged in an array, and
an orthographic projection of the array formed by the plurality of phase adjustment units on a plane where the light outlet is located, at least partially, overlaps with the light outlet.
